(19) United States
(12) Patent Application Publication
(10) Pub. No.: US 2013/0136551 A1
(43) Pub. Date: May 30, 2013

(54) GUIDE PAD, CUTTING TOOL BODY AND CUTTING TOOL

(71) Applicant: Tungaloy Corporation, Iwaki-shi (JP)

(72) Inventor: Koji NISIKAWA, Iwaki-shi (JP)

(73) Assignee: Tungaloy Corporation, Iwaki-shi (JP)

(21) Appl. No.: 13/750,798

(22) Filed: Jan. 25, 2013

Related U.S. Application Data
(63) Continuation-in-part of application No. PCT/JP2012/052762, filed on Feb. 7, 2012.

(30) Foreign Application Priority Data
Feb. 28, 2011 (JP) 2011-041870

(51) Int. Cl. B23B 51/00

(52) U.S. Cl. CPC B23B 51/0054
USPC 408/83; 408/241 G

(57) ABSTRACT

A guide pad with a high freedom degree of arrangement is provided. A plate-shaped guide pad includes top and bottom surfaces, and a side surface that extends between the top surface and the bottom surface, and is removably attached to a tool body of a cutting tool. The side surface has at least one guide surface.

### CROSS-REFERENCE TO RELATED APPLICATIONS

This application is a continuation-in-part of PCT application No. PCT/JP2012/052762, filed Feb. 7, 2012 and published as WO 2012/117817A1, which claims the benefit of Japanese Patent Application 2011-041870, filed Feb. 28, 2011. The contents of the aforementioned applications are incorporated by reference in their entirety.

### BACKGROUND OF THE INVENTION

### Field of the Invention

The present invention relates to a guide pad removably attached to a cutting tool for supporting the cutting tool, a cutting tool body to which the guide pad is attached, and the cutting tool having the guide pad attached thereto.

As the conventional guide pad, the applicant has disclosed in Japanese Patent Laid-Open No. 2004-314258. The guide pad is formed into a substantially rectangular plate shape, has a mounting hole, is attached to a drill, and is guided along an inner wall surface of a machining hole machined with the drill. Two curved surfaces each having a substantially arc-like cross-section and constituting guide surfaces are not formed on a side surface, but rather on an top surface in a substantially rectangular contour shape of the guide pad. The conventional guide pad is disclosed in Pamphlet of International Application Publication. That is, it contains a cemented carbide member in a substantially rectangular plate shape, has a mounting hole, and has an extending wing-shaped protrusion around the mounting hole. The guide surface is not limited to the one with the substantially arc-like cross-section, but may be formed in a planar shape. In the guide pad disclosed in Pamphlet of International Application Publication, too, the guide surface is formed not on the side surface, but on the top surface with the substantially rectangular contour shape.

For example, in a cutting tool with a single cutting edge for drilling a hole, generally, it is preferable to provide a guide pad at two positions: a 180° position around an axis of rotation with respect to the cutting edge; and a 90° position backward in a relative rotating direction of the tool with respect to the cutting edge, when seen from the leading end of the tool. In other words, it is preferable to provide it at the farthest position from the cutting edge, and at the position that receives a principal component of cutting force as the largest among three components of cutting force. However, when the tool diameter that defines the machining hole diameter is relatively small, it is sometimes difficult to provide the guide pad at such preferable positions.

For a two-cutting-edge solid drill having two cutting edges, it is preferable to arrange guides (margin) each at a 90° position around an axis of rotation from the respective cutting edges. This is because at a 180° position around an axis of rotation with respect to one cutting edge, the other cutting edge surely exists. Likewise, it is preferable to provide the guide pads for an indexable drill having two or more cutting edges at substantially equidistant positions from a plurality of cutting edges of the drill. However, there are a large number of parts around a leading end of the indexable drill having two or more cutting edges, and accordingly, it is sometimes difficult to arrange the plurality of guide pads at desired positions.

A main reason thereof is interference of a cutting insert or a fastening mechanical part for the cutting insert with the guide pad. Therefore, it is preferable to use the guide pad having no interference, specifically having interference as small as possible, with the other components. However, the wall around the mounting hole is required to have sufficient strength for fastening of the guide pad with a clamp screw and the like. As the guide pad disclosed in in Japanese Patent Laid-Open No. 2004-314258 is fastened with the clamp screw, the guide pad is configured to have the width larger than that of the head of the clamp screw. Accordingly, there is a limit to make the guide pad small or reduce its width. The guide pad disclosed in Pamphlet of International Application Publication is entirely formed of a cemented carbide, which is suitable for reducing the size and the width. However, the wing-shape protrusions left-right symmetrically protruding from two long sides of the guide pad are likely to be interfered with the other parts.

### SUMMARY OF THE INVENTION

The present invention provides a guide pad that provides flexibility in arrangement, a cutting tool body to which the guide pad is attached, and a cutting tool having the guide pad attached thereto.

The guide pad according to the present invention is a guide pad (1) formed in a plate-like shape, including:

opposite top and bottom surface surfaces (2, 3); and

a peripheral side surface (16) extending between the top surface (2) and the bottom surface (3), the guide pad being removably attached to a tool body (10) of a cutting tool. The peripheral side surface (16) comprises at least one guide surface (4a).

The cutting tool according to the present invention includes the above-described guide pad (1) and a tool body (10) to which the guide pad (1) is attached.

The cutting tool body (10) according to the present invention includes a pad seat that allows reception of the above-described guide pad (1).

### Advantageous Effects of Invention

The guide pad according to the present invention has a guide surface formed on a side surface that extends between the top and bottom surfaces. That is, the guide surface is formed on the side surface instead of the top surface of the guide pad formed into a plate shape so as to improve the freedom degree of arrangement of the guide pad.

Further features of the present invention will become apparent from the following description of exemplary embodiments (with reference to the attached drawings).

### BRIEF DESCRIPTION OF THE DRAWINGS

FIG. 1 is a perspective view of a guide pad according to a first embodiment;

FIG. 2 is a plan view of the guide pad shown in FIG. 1;

FIG. 3 is a front view of the guide pad shown in FIG. 2;

FIG. 4 is a right side view of the guide pad shown in FIG. 2;

FIG. 5 is a perspective view of a rotary cutting tool with the guide pad shown in FIG. 1 attached thereto according to an embodiment;

FIG. 6 is a perspective view of the cutting tool shown in FIG. 5 when seen from another direction;

FIG. 7 is a front view of the rotary cutting tool shown in FIG. 5; and

FIG. 8 is a perspective view of a guide pad according to a second embodiment.

### DETAILED DESCRIPTION

Embodiments according to the present invention will be described referring to the drawings.

### First Embodiment

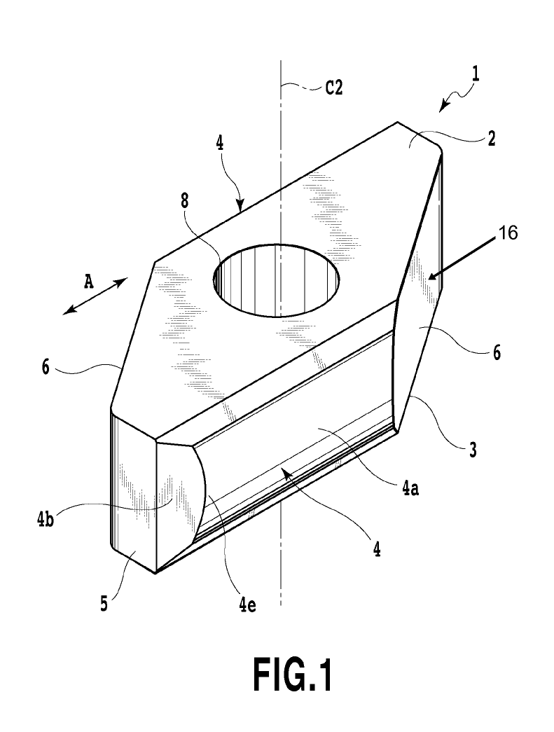

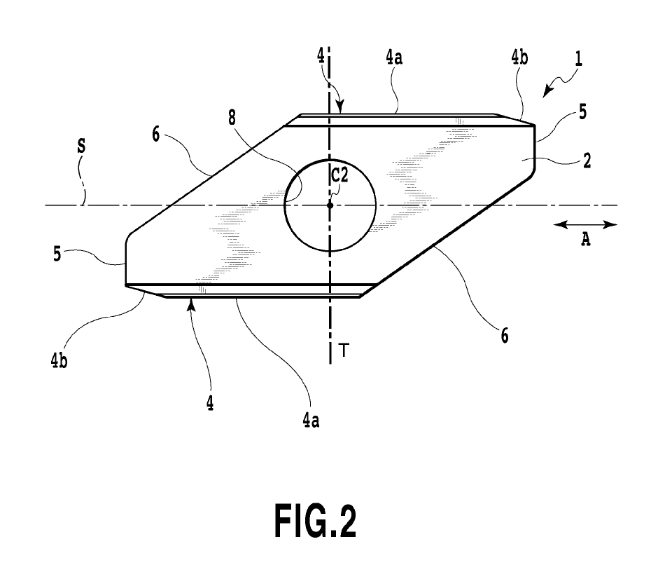

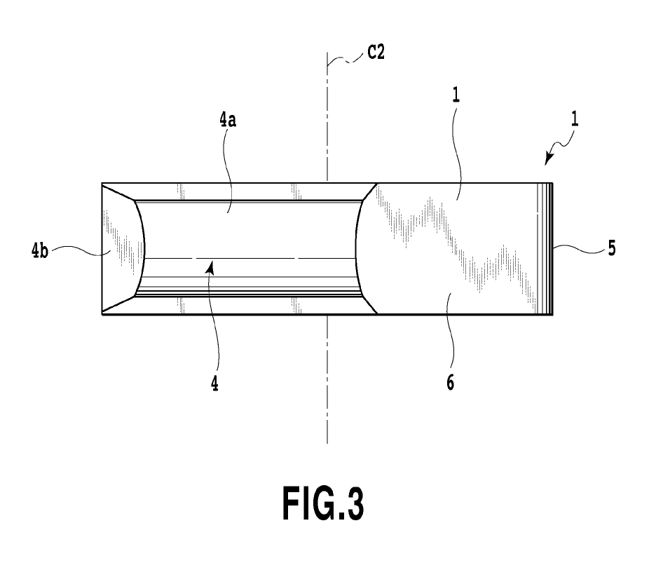

Referring to FIGS. 1 to 4, a guide pad 1 according to the embodiment has flat plate-like shape and includes opposite top and bottom surfaces 2 and 3, and a peripheral side surface 16 which extends between the top surface 2 and the bottom surface 3 and includes plurality of pairs of opposing side surfaces 4, 5 and 6. Each contour shape of the top surface 2 and the bottom surface 3 is substantially parallelogrammatic. In the embodiment, an acute-angled corner of the substantially parallelogrammatic contour shape of the guide pad 1 is set to have the angle of approximately 35.0°, which is not limited thereto. The contour shapes of the top surface 2 and the bottom surface 3 are truncated at the acute-angled corners, and thus may be seen as a substantially hexagonal shape. Among the plurality of side surfaces 4, 5 and 6, the two opposing lateral side surfaces 5, 5 extending perpendicular to a longitudinal direction A are substantially formed of planes, and are arranged substantially in parallel with each other. The two connecting side surfaces 6, 6 appear linear in the plan view of FIG. 2, are also substantially formed of planes, and are arranged substantially in parallel with each other. The two major side surfaces 4, 4 are also arranged substantially in parallel with each other and extend along the longitudinal direction A, but the configuration thereof will be described later. Since the guide pad 1 is not configured for cutting the intersections of the guide pad's top surface 2 and bottom surface 3, with the peripheral side surface 16, are devoid of cutting edges.

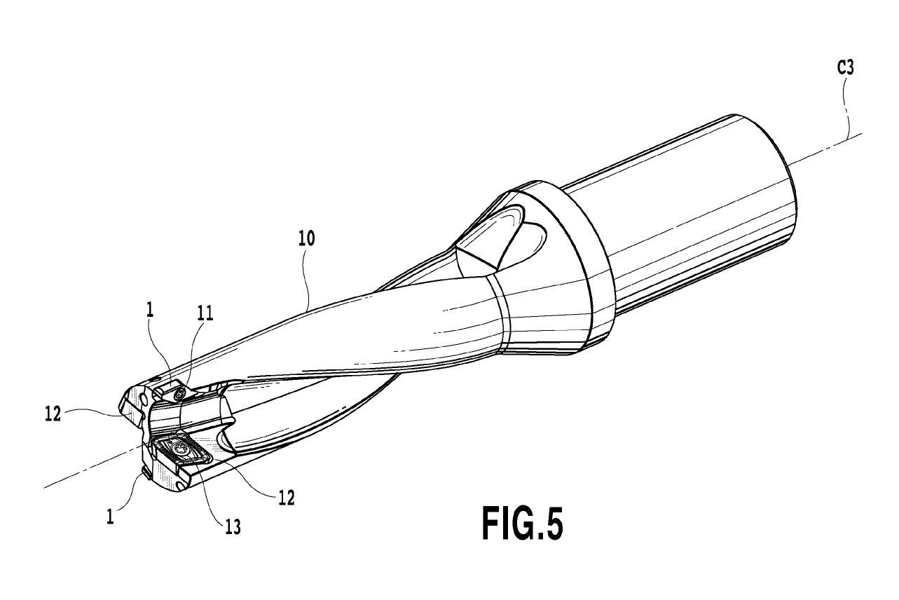

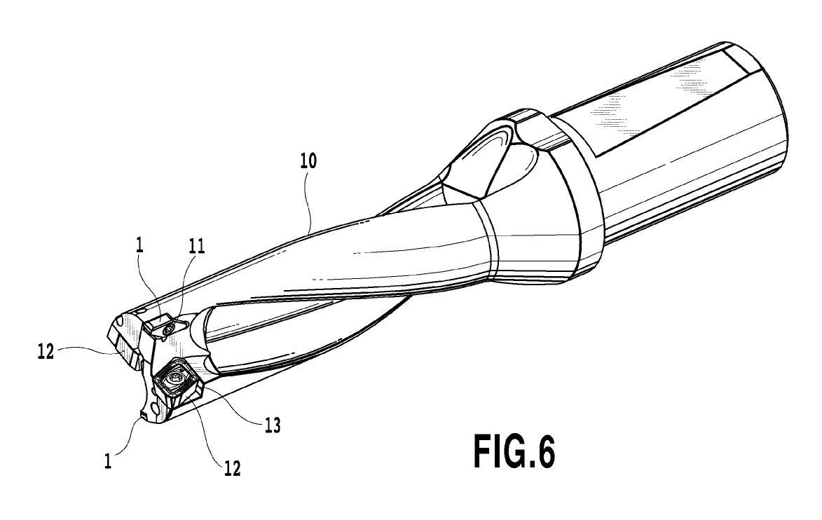

The guide pad 1 is removably attached to a tool body 10 of a rotary cutting tool (indexable drill) as shown in FIGS. 5 and 6, for example. In this case, the guide pad 1 is attached so that the longitudinal direction A is in parallel with an axis of rotation C3 of the rotary cutting tool. A guide surface 4a is formed on the major side surface 4. The guide surface 4a is formed as a curved surface with a curvature radius R having a substantially arc-like cross-section, and extends in the longitudinal direction A. During a drilling operation, the guide surface 4a is partially in contact with an inner wall surface of a machining hole that is machined by the drill, and serves to support the drill. This operation guides the drill to the machining hole, resulting in improved straightness of the drill. A forward end portion 4e of the guide surface 4a proximate to the connecting surface 5 is located at the tip side of the drill during a drilling operation and is positioned so as to be in contact with the inner wall surface of the machining hole. That is, the guide pad 1 is placed while being slightly tilted so that the portion other than the area around the operative forward end 4e of the guide surface 4a is free from contact. That the guide pad 1 is removably attached to the cutting tool means easy replacement. For example, it indicates the case where the guide pad 1 is fixed with a clamp screw 11 and the like. The method of attaching the guide pad 1 is not limited to the use of the clamp screw 11, but various known attaching methods may be employed.

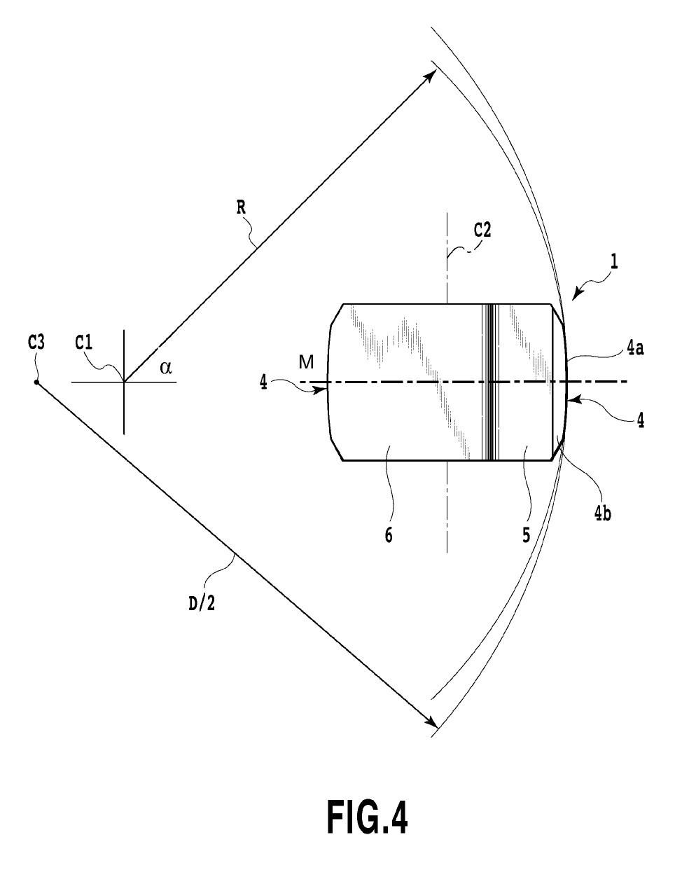

The specific shape of the guide surface 4a is defined by its curvature radius R that is smaller than half of a diameter D of the guide hole as shown in FIG. 4. The guide hole denotes the hole through which the guide pad is guided in the similar way as the aforementioned machining hole. When the guide pad 1 is attached to the indexable drill with the machining hole diameter of approximately 32 mm, for example, the curvature radius R may be set to approximately R=15.0 mm. If the curvature radius R is larger than the half of the diameter D of the machining hole, the guide surface 4a does not contact the machining hole serving as the guide hole and fails to provide the guide function, and an edge of the guide surface 4a contacts the machining hole as a result. Contact of the edge of the guide surface 4a with the inner wall surface of the machining hole may damage the inner wall surface thereof.

In the embodiment, as the curvature radius R of the guide surface 4a is kept constant, the center of the curvature of the guide surface 4a is located on an axis line C1 as shown in FIG. 4. The axis line C1 is a straight line that extends in a vertical direction with respect to the drawing of FIG. 4 (i.e., into the drawing sheet) along the longitudinal direction A. As seen in FIG. 4, the curvature radius R for one guide surface 4a is centered about an axis line C1 which is on the far side of the other guide surface 4a. As also seen in FIG. 4, the axis line C1 may be parallel to the axis of rotation C3 of the tool.

The embodiment will be explained with respect to the case where the curvature radius R is kept constant. However, the present invention is not limited to the aforementioned case, and is also applied to, for example, cases in which the curvature radius R of the guide surface 4a varies in the longitudinal direction A (i.e., R changes along axis line C1), and the curvature of arc varies in accordance with the position on the arc (i.e., R changes as function of an angle α about axis line C1, and so a curvature of the guide surface 4a changes in accordance with distance from a median plane M of the guide pad 1, the median plane being midway between the top and bottom surfaces, containing axis line C1, and perpendicular to center axis line C2 about which the guide pad has 180° rotational symmetry. A part of the guide surface 4a may be formed as the plane.

As shown in FIG. 2, the guide pad 1 has a single mounting hole 8 formed therein that penetrates the top surface 2 and the bottom surface 3. The guide pad 1 is formed 180° rotationally symmetrical with respect to a center axis line C2 of the mounting hole 8. The plane that contains the axis line C2 and passes centrally between and parallel to the two major side surfaces 4, 4 is set as a reference plane S. A transverse plane T perpendicularly intersects the major side surfaces 4, 4 and the reference plane S, the transverse plane (T) intersecting the reference plane (S) at the central axis line (C2). As known from FIG. 2, the contour shapes of the top surface 2 and the bottom surface 3 of the guide pad 1 are formed to be asymmetrical with respect to the reference plane S, and also with respect to the transverse plane T. In other words, the top surface 2 and the bottom surface 3 have left-right asymmetrical contour shapes and also top-bottom asymmetrical contour shapes with no axis of symmetry in any direction. In other words, the top surface 2 and the bottom surface 3 do not have minor symmetry with respect to either the reference plane S or the transverse plane T.

A part of the major side surface of the guide pad 1, which includes one of the two guide surfaces 4a serves as a seating surface upon attachment to the tool body 10. A part of the bottom surface 3 of the guide pad 1 also serves as the seating surface upon attachment to the tool body 10.

The guide pad 1 according to the present invention has a guide pad body entirely formed of the material of cemented carbide, cermet, or ceramic. A hard film may be coated on the surface of the aforementioned hard guide pad body. In other words, the steel material and brazing material do not have to be used as the material for forming the guide pad 1 according to the present invention. This makes it possible to reduce the size of the guide pad 1, thus improving the flexibility in arrangement on the tool body 10.

Preferably, a chamfer is appropriately provided around the edge of the guide surface 4a. For example, it is possible to form the guide surface 4a entirely on the major side surface 4, but in this case, the edge of the guide surface 4a may damage the inner wall surface of the machining hole. The width of the guide surface 4a may be arbitrarily set within a range of the plate thickness of the guide pad 1. The width of the guide surface 4a may be made narrower than the plate thickness of the guide pad 1 by forming a stepped portion and an inclined portion on the major side surface 4. The width of the guide surface 4a may vary in the longitudinal direction A. The plate thickness of the guide pad 1 is appropriately adjusted so that the head of the clamp screw 11 is reliably hidden and the fastening strength is secured. It is preferable to set the width of the guide surface 4a to be narrower than the plate thickness of the guide pad 1 in terms of avoiding the interference with the other components. If there is no concern about interference with the other components, there is a case that with the same width, it is possible to suppress the manufacturing costs without generating excessive processing costs.

Dimensions of the top surface 2 and the bottom surface 3 of the guide pad 1 may be appropriately adjusted so as not to interfere with the other components, and to reduce the overall dimension while keeping the strength. In the embodiment, a clamp screw 13 for a cutting insert 12 is employed as the fastening part with which the cutting insert 12 is attached to the tool body 10. The guide pad 1 is designed in consideration of the interference with the clamp screw 13 for the cutting insert 12, and a prepared hole for the female screw, which are hard to see from the surface. The fastening part for the cutting insert 12 is not limited to the clamp screw 13, but various types of related art may be applied. In such a case, the guide pad 1 is arranged so as to avoid interference with all the parts.

On the major side surface 4, a chamfer 4b is formed at a portion of the guide surface 4a near one end 4e thereof. It is intended to prevent the guide pad 1 from damaging the inner wall surface of the machining hole, and from causing abnormal damage such as chipping. The guide surface 4a is adjusted so that only the end region 4e in the vicinity of the chamfer 4b serves as a guide surface, and a clearance from the inner wall surface of the machining hole is secured as the distance from the end region 4e increases.

In the embodiment, the curvature radius R of the guide surface 4a is kept constant, but the invention is not limited thereto. It is possible to positively change the curvature radius R of the guide surface 4a to appropriately adjust the resultant gap between the guide surface 4a and the inner wall surface of the machining hole.

Joint portions of the respective side surfaces 4, 5 and 6 of the guide pad 1 are rounded to prevent the abnormal damage such as chipping. In the embodiment, each curvature radius of all the rounded corners at 6 points may be set to approximately R=0.4 mm. The size of the roundness of approximately 0.4 mm allows easy formation, which is sufficient to prevent the abnormal damage such as chipping.

The indexable drill is a typical example of a cutting tool that allows removable attachment of the guide pad 1. Alternatively, it is effective for the cutting tool especially used for drilling work, such as the gun drill and reamer. However, it is not limited to those described above. It is applicable to many kinds of cutting tools which use the guide pad.

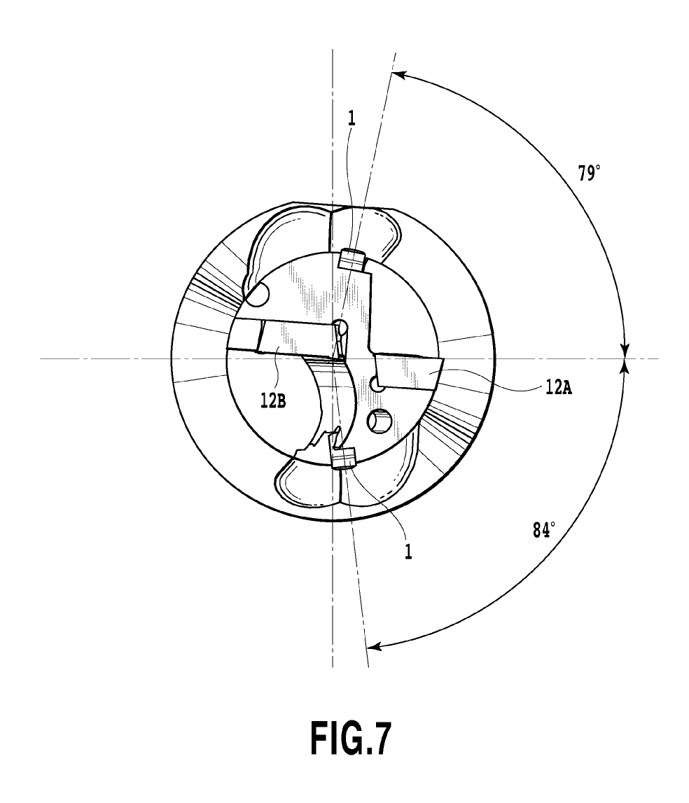

The drill to which the guide pad 1 is attached according to the embodiment is configured to have the guide surface 4a of the guide pad 1 arranged at the position as shown in FIG. 7. A position of a tip of the peripheral cutting edge is set to a reference angle 0° as the angle measurement criterion. The position of the cutting edge at the outermost circumference is set as the reference since the guide pad 1 is intended to support the drill in the radial direction. For the single cutting-edge structure, the optimal positions of the guide surfaces 4a are set to two positions, at a 180° position forward in the relative rotating direction of the tool from the cutting edge, and at a 90° position backward in the relative rotating direction of the tool from the cutting edge. Meanwhile, for the two-cutting-edge solid drill for balance cut, each position is set at a 90° position from the cutting edge, respectively.

In the embodiment, the optimal positions are set at 90° positions forward and backward from the cutting edge, respectively on the assumption of use of the two-cutting-edge drill. As a result of aiming at the 90° positions forward and backward from the cutting edge, respectively, the guide pad 1 is set at two positions of an approximately 79° forward in the relative rotating direction of the tool from the cutting edge of the peripheral cutting edge, and an approximately 84° position backward in the relative rotating direction of the tool from the cutting edge. The deviation amounts from the optimal positions are approximately 11° (90°-79°) and 6° (90°-84°), respectively. If the conventional guide pads are arranged with the tool of the same type, limits of the respective deviation amounts are approximately 45° and 23°. The use of the guide pad 1 according to the present invention improves the deviation amounts by approximately 45° and 13°, respectively. The experimental results of attachment to the indexable drill for drilling of the steel material show the improvement in accuracy of the machining hole diameter by approximately 20%.

Specifically, the drill with the diameter of 50.0 mm and whole length of 370 mm was attached to a vertical machining center, and a carbon steel S45 C (220HB) was used as the work material. The cutting speed Vc=150 m/min, feed f=0.10 mm/rev, and the depth of the machining hole of 150 mm were set as the conditions for cutting, and the coolant was supplied through the inside of the drill. The drill having the guide pad 1 according to the embodiment attached thereto, the drill having the conventional guide pad attached thereto, and the drill without the guide pad were used to machine the work materials to drill 12 holes, respectively. Each variation in the diameter of the machined hole was evaluated. The variation in the machining hole diameters by the drill having the guide pad 1 according to the embodiment attached thereto resulted in approximately 0.14 mm as the difference in the diameter of the machining hole between the portion around the inlet part and the portion at the deep part. Meanwhile, the difference generated when using the drill without the guide pad resulted in approximately 0.24 mm, and the difference generated when using the drill having the conventional guide pad attached thereto resulted in approximately 0.17 mm. The use of the drill having the guide pad according to the embodiment attached thereto improved the accuracy of the machining hole by approximately 20% (100×(17−14)/17)) at a maximum compared to the use of the drill with the conventional guide pad.

As FIG. 5 shows, the guide pad 1 according to the embodiment may be provided on the surface of a chip discharge groove of the drill. In such an arrangement, the guide pad 1 is easily attachable. Since it is arranged at the position close to the tip end of the chip discharge groove, the secondary effect may be expected which prevents the damage to the chip discharge groove and deterioration in the surface roughness irrespective of the contact with the high-temperature chip immediately discharged from the cutting edge. This allows contribution to improvement in chip discharging property by positively providing the pattern for discharging the chip (not shown).

It is preferable that the surface on which the guide pad 1 is placed is in parallel with the axis of rotation C3 of the tool. The arrangement on the surface is likely to make the guide surface 4a in parallel with the axis of rotation C3 of the tool, thus allowing the guide pad 1 to be simply shaped, and the guide pad 1 to be easily attached. However, the arrangement is not limited to the one as described above. For example, the guide pad 1 may be provided on the twisted surface so long as the guide surface 4a is shaped to be adaptable to the twisting.

The cutting tool to which the guide pad 1 is removably attached is removably mounted on the machine tool such as the machining center and lathe, receives rotating motion around the axis of rotation C3 as the center, and the relative movement with respect to the work material so that the work material such as the steel material is subjected to the cutting process. If the cutting tool is the drill, the guide pad 1 is brought into contact with the inner wall surface of the hole drilled by itself, and guided by the hole to improve the precision of working of the hole to be machined. The guide pad 1 and the cutting tool may be used in the machine tool such as the drill press.

The guide pad 1 is formed into a shape 180° rotationally symmetrical with respect to the center axis line C2 of the mounting hole 8. This is intended to allow the usage of the guide pad twice or more times by providing two or more tip portions upon attachment of the guide pad 1 to the tool body 10 of the cutting tool. In other words, after using one of the guide surfaces 4a, the guide pad 1 is rotated at 180° around the center axis line C2 so as to allow the use of the other guide surface 4a. The part that hardly affects the attachment to the tool body 10 and the guide by the guide surface 4a does not have to be formed into a shape line symmetrical with respect to the center axis line C2 of the mounting hole 8. The design may be arbitrarily changed by applying the concavo-convex portion so as not to affect the cutting performance.

### Second Embodiment

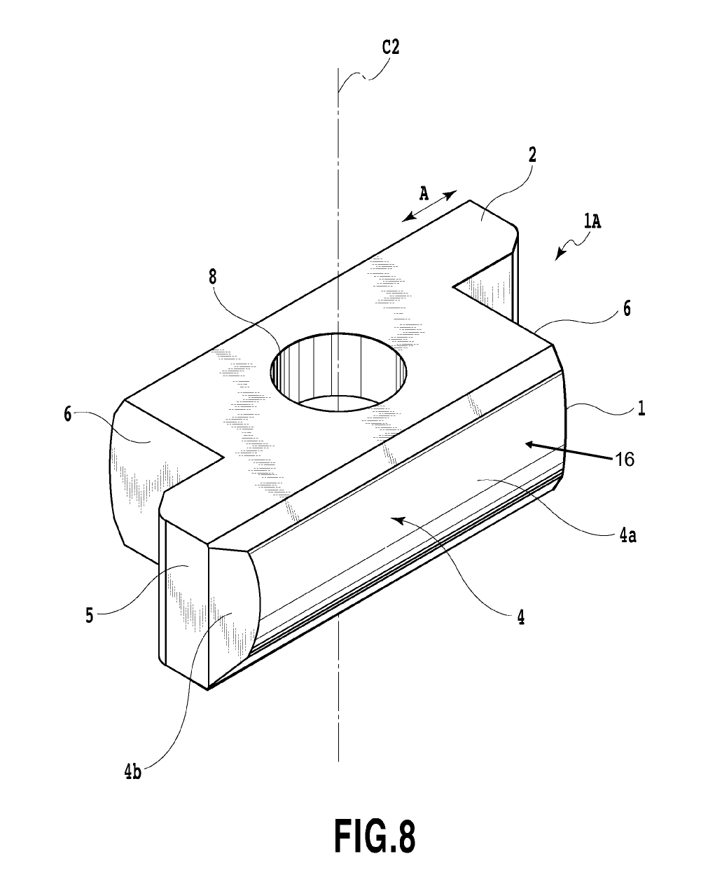

The contour shape of the guide pad according to the present invention is not limited to the substantially parallelogrammic plate shape as described in the first embodiment. The design of the contour shape of the guide pad according to the present invention may be changed appropriately by applying the concavo-convex portion to the respective sides within a range not affecting the cutting performance. The guide surface having the convex curved surface formed on the side surface of the guide pad represents the characteristic of the present invention. A guide pad lA according to a second embodiment will be described referring to FIG. 8. As seen in FIG. 8, the connecting side surfaces 6, 6, may be non-linear rather than linear, without affecting the configuration of the guide surface 4a.

According to the first and the second embodiments as described above, two guide surfaces 4a are formed. However, the number of the guide surfaces 4a is not limited to such value. For example, if the number of usage is set to three or more times, three or more guide surfaces 4a may be provided accordingly. For example, the guide pad may have a substantially regular polygonal plate shape such as a substantially triangular plate shape and a substantially square plate shape (not shown).

The conventional guide pad manufacturing method may be directly used as the method of manufacturing the guide pad 1. For example, manufacturing is conducted through the conventional manufacturing steps using the powder-pressurizing molding process and sintering. The grinding work such as the guide surface 4a and chamfering may be added if needed. Furthermore, it may be subjected to the surface treatment such as coating of the hard material film through CVD and PVD if necessary. Various types of conventional technique may be applied to all the manufacturing steps.

The present invention is not limited to the embodiments as described above, but may allow appropriate change, addition and omission of the configuration without departing from the gist of the present invention. For example, it is also possible to provide, in the top surface, the groove corresponding to the chip discharge groove of the tool body 10 of the cutting tool and cause the groove to function as a part of the chip discharge groove while obtaining the similar effects as those of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A guide pad having a plate-like shape and removably attachable to a tool body of a cutting tool, the guide pad comprising:
opposite top and bottom surfaces, the bottom surface being configured to serve as a seating surface; and
a peripheral side surface extending between the top surface and the bottom surface; wherein
the peripheral side surface comprises at least one guide surface.

2. The guide pad according to claim 1, wherein the at least one guide surface is curved convexly and extends in a longitudinal direction of the guide pad.

3. The guide pad according to claim 1, wherein
the peripheral side surface comprises opposite first and second major side surfaces; and
the at least one guide surface comprises first and second guide surfaces formed on the opposite first and second major side surfaces, respectively.

4. The guide pad according to claim 1, wherein the top and bottom surfaces have left-right asymmetrical contour shapes.

5. The guide pad according to claim 4, wherein the top and bottom surfaces have contour shapes in a substantially parallelogram shape.

6. The guide pad according to claim 5, wherein the substantially parallelogram shape has a truncated acute-angled corner.

7. The guide pad according to claim 1, further comprising a single mounting hole that penetrates the top surface and bottom surfaces, wherein the guide pad is formed 180° rotationally symmetric with respect to a center axis line of the mounting hole.

8. The guide pad according to claim 1, wherein a guide pad body thereof is formed only of one from the group consisting of cemented carbide, cermet and ceramic.

9. The guide pad according to claim 8, wherein a hard coating is coated on a surface of the guide pad body.

10. A cutting tool body comprising a pad seat configured to receive the guide pad according to claim 1.

11. A cutting tool comprising:
the guide pad according to claim 1; and
a tool body to which the guide pad is attached.

12. A guide pad having a plate-like shape and removably attachable to a tool body of a cutting tool, the guide pad comprising:
opposite top and bottom surfaces, the bottom surface being configured to serve as a seating surface;
a mounting hole passing through the top and bottom and having a central axis line (C2) around which the guide pad has 180° rotational symmetry;
a peripheral side surface extending between the top surface and the bottom surface, the peripheral side surface including at least two major side surfaces extending along a longitudinal direction (A) of the guide pad, at least two laterally extending side surfaces which are shorter than the major side surfaces, and at least two connecting side surfaces connecting the major side surfaces with the laterally extending side surfaces;
first and second guide surfaces formed on the major side surfaces, each guide surface having a curvature radius (R) which is centered about an axis line (C1) on a far side of the other guide surface and parallel to the longitudinal direction (A); a reference plane (S) containing the central axis line (C2) and parallel to the axis line (C1), the reference plane bisecting the top and bottom and passing centrally between the major side surfaces; and
a transverse plane (T) intersecting both of the major side surfaces and perpendicular to the reference plane (S), the transverse plane (T) intersecting the reference plane (S) at the central axis line (C2) about which the guide pad has 180° rotational symmetry; wherein,
the top and bottom surfaces are not mirror-symmetric with respect to either the reference plane (S) or the transverse plane (T), though the guide pad has 180° rotational symmetry about the intersection of the reference plane (S) and the transverse plane (T).

13. The guide pad according to claim 12, wherein the connecting surfaces are linear in a plan view of the guide pad.

14. The guide pad according to claim 12, wherein the connecting surfaces are non-linear in a plan view of the guide pad.

15. The guide pad according to claim 12, wherein the curvature radius (R) of the guide surface changes in the longitudinal direction (A) along the axis line (C1).

16. The guide pad according to claim 12, wherein the curvature radius (R) changes as a function of an angle (α) about the axis line (C1), so that a curvature of the guide surface changes as a function of distance from a median plane (M) of the guide pad, the median plane (M) being midway between the top and bottom surfaces, containing axis line (C1), and perpendicular to the central axis line (C2) about which the guide pad has 180° rotational symmetry.

17. A cutting tool body comprising a pad seat configured to receive the guide pad according to claim 12.

18. A cutting tool comprising:
the guide pad according to claim 12; and
a tool body to which the guide pad is attached.

19. The cutting tool according to claim 18, wherein the cutting tool is a rotary cutting tool for drilling;
the cutting tool has an axis of rotation (C3); and
the axis line (C1) is parallel to the axis of rotation (C3) of the tool.
